(19) United States
(12) Patent Application Publication
(10) Pub. No.: US 2015/0274124 A1
(43) Pub. Date: Oct. 1, 2015

(54) VEHICULAR STARTING DEVICE

(71) Applicant: KABUSHIKI KAISHA HONDA LOCK, Miyazaki-shi (JP)

(72) Inventor: Jin YUKIHARA, Miyazaki-shi (JP)

(21) Appl. No.: 14/666,727

(22) Filed: Mar. 24, 2015

(30) Foreign Application Priority Data
Mar. 27, 2014 (JP) 2014-066397

(51) Int. Cl. B60R 25/045

(52) U.S. Cl. CPC B60R 25/045

(57) ABSTRACT

A vehicular starting device includes: a rotor configured to turn around a rotational axis at least between an on-position that causes a power unit of a vehicle to start and an off-position that causes the power unit to stop, the rotor being configured to slide in a rotational axial direction, an operator configured to operate the rotor, a range switching unit configured to switch a running state of the vehicle between a forward movement position that allows the vehicle to move forward and a backward movement position that allows the vehicle to move backward, and an acting member configured to cause the range switching unit to switch the running state with a slide movement of the rotor.

### CROSS-REFERENCE TO RELATED APPLICATION

This application claims priority from Japanese Patent Application No. 2014-066397 filed with the Japan Patent Office on Mar. 27, 2014, the entire content of which is hereby incorporated by reference.

### BACKGROUND

1. Technical Field

This disclosure relates to a vehicular starting device.

2. Description of the Related Art

Recently, what is called a shift-by-wire system attracts attention, which switches the running state of a vehicle (hereinafter, referred to as range) based on an electric signal. The shift-by-wire system switches a range by drivingly controlling an actuator with an electric signal generated by shift switching operation.

For example, Japanese Patent No. 2588481 discloses an automatic shift unit that includes a selecting cylinder element and a selecting slide element. The selecting cylinder element has a guide groove into which a key element is inserted, and can turn around a rotational axis. The selecting slide element houses the selecting cylinder element, and can slide in the in-plane direction perpendicular to the rotational axis. In this unit, the turn operation of the selecting cylinder element by the key element, whose grip portion (selecting operation member) is held, switches the range from a parking position (P) to a neutral position (N). Then, the slide operation of the selecting slide element, which is in the neutral position (N), in the in-plane direction (direction perpendicular to rotational axis) switches the range from the neutral position (N) to a forward movement position (D) or a backward movement position (R).

### SUMMARY

A vehicular starting device includes: a rotor configured to turn around a rotational axis at least between an on-position that causes a power unit of a vehicle to start and an off-position that causes the power unit to stop, the rotor being configured to slide in a rotational axial direction, an operator configured to operate the rotor, a range switching unit configured to switch a running state of the vehicle between a forward movement position that allows the vehicle to move forward and a backward movement position that allows the vehicle to move backward, and an acting member configured to cause the range switching unit to switch the running state with a slide movement of the rotor.

### BRIEF DESCRIPTION OF THE DRAWINGS

FIG. 1 is a front view of a vehicular starting device;

FIG. 2 is a schematic configuration diagram of a vehicle, which includes a cross-sectional view of the vehicular starting device;

FIGS. 3A to 3F are front views of a displaying unit;

FIG. 4 is an operation explanatory view of the vehicular starting device, and is a front view corresponding to FIG. 1; and

FIG. 5 is an operation explanatory view of the vehicular starting device, and is a cross-sectional view corresponding to FIG. 2.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the unit according to the above-described Japanese Patent No. 2588481, the switching operation between the forward movement position and the backward movement position involves turning the selecting cylinder element to the neutral position, and then sliding the selecting slide element in the in-plane direction (direction perpendicular to rotational axis). Such a structure may disadvantageously result in the complexity of the unit. In addition, the turning operation of the selecting cylinder element and the slide operation of the selecting slide element in the in-plane direction are performed by the key element whose grip portion is held. This may apply a strong bending stress or a strong shearing stress to the key element. This may result on, for example, the upsizing of the key element for increasing the strength of the key element. Furthermore, the operation of a driver is complicated since the switching operation between the forward movement position and the backward movement position is performed by slide movement of the selecting slide element in the in-plane direction.

An object of this disclosure is to provide a vehicular starting device that has a simple and small configuration, as well as provides high operability.

A vehicular starting device according to one embodiment of the present disclosure (this starting device) includes: a rotor configured to turn around a rotational axis at least between an on-position that causes a power unit of a vehicle to start and an off-position that causes the power unit to stop, the rotor being configured to slide in a rotational axial direction, an operator configured to operate the rotor, a range switching unit configured to switch a running state of the vehicle between a forward movement position that allows the vehicle to move forward and a backward movement position that allows the vehicle to move backward, and an acting member configured to cause the range switching unit to switch the running state with a slide movement of the rotor.

According to this starting device, the slide operation of the rotor in the rotational axial direction can switch the range to the forward movement position or the backward movement position. This can realize a simple and small configuration of the unit compared with a conventional unit that switches the range by sliding its member in the direction perpendicular to the rotational axis direction. Furthermore, the incorporation of the range switching unit into the vehicular driving device that generates rotational movement can suppress cost increase associated with employing a shift-by-wire system. In addition, this eliminates a need for a select lever and a coupling mechanism between the select lever and a forward and backward movement switching unit, which are conventionally used. This can decrease the number of components, and also can improve space efficiency. In addition, this starting device has a configuration in which the rotor slides along the rotational axis. This can suppress a bending stress and a shearing stress applied to an operator, which can downsize the operator. Furthermore, the slide movement of the rotor in the rotational axial direction via the operator can switch the range. Accordingly, this starting device has higher operability. Namely, with this starting device, the driver can switch the range, for example, without seeing his or her hand, what is called, blind operation. Accordingly, this starting device can reduce the sight movement of the driver while switching the range.

In the vehicular starting device, the range switching unit may include: a select switch configured to output, with being pushed, an operation signal indicating the forward movement position or an operation signal indicating the backward movement position, and a control unit configured to switch the running state of the vehicle in response to the operation signal. In addition, the select switch may be disposed at an outside of the rotor in a radial direction of the rotor, the acting member may include: a pushing member configured to push the select switch; and a groove portion disposed on an outer peripheral surface of the rotor, the groove portion housing an inner end portion of the pushing member in a radial direction of the rotor. The groove portion may include an inclined surface that is inclined in a slide direction of the rotor. The inclined surface may be configured to cause, with the slide movement of the rotor, the pushing member to move toward the outside of the rotor in the radial direction of the rotor to cause the pushing member to push the select switch. Moreover, in this starting device, the control unit may switch the running state of the vehicle when receiving the operation signal from the select switch while a brake of the vehicle is in an on-state.

According to this configuration, the control unit switches the range when receiving an operation signal from the select switch while the brake is in an on-state. This inhibits and suppresses that the range are accidentally switched while the vehicle is travelling.

The control unit may be configured to switch the running state of the vehicle when receiving the operation signal from the select switch while a brake of the vehicle is in an on-state. Moreover, the control unit may be configured to avoid switching the running state of the vehicle when receiving the operation signal from the select switch while a brake of the vehicle is in an off-state. In addition, this starting device may include a display unit configured to display an operating state of the select switch and the power unit.

According to this configuration, the display unit displays the operating state of the select switch and the power unit. This allows the driver to easily recognize the operating state. This can further improve operability.

This starting device may further include an alarm unit configured to notify that the running state of the vehicle is in the backward movement position.

According to this configuration, the alarm unit can notify that the range is in backward movement position. This allows the driver to easily recognize that the range is in backward movement position. This also can further improve operability.

This disclosure can provide a vehicular starting device that has a simple and small configuration, as well as provides high operability.

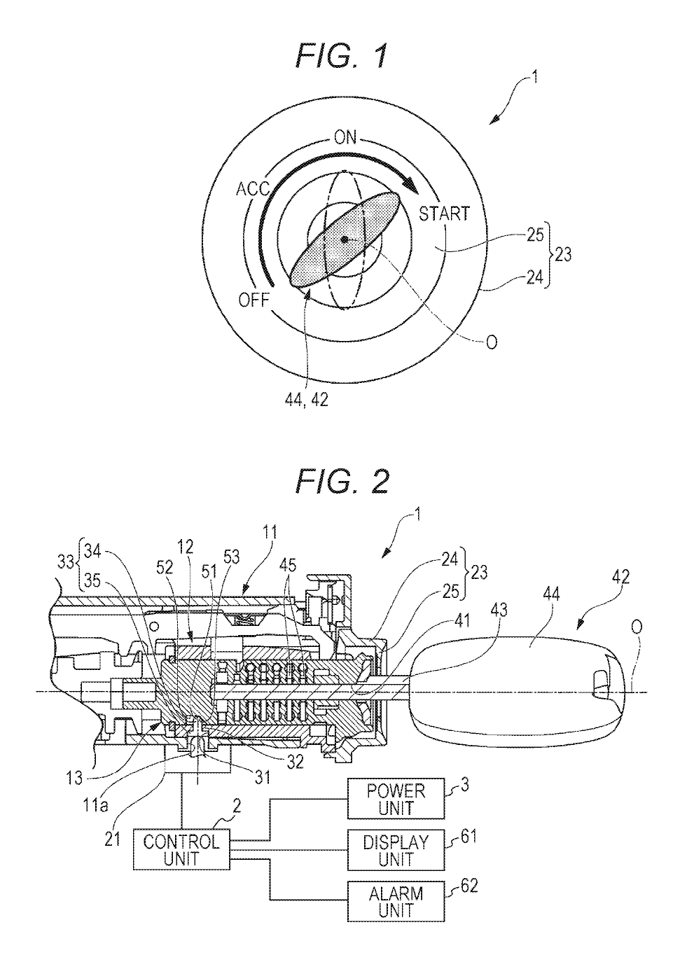

The following describes the embodiment of this disclosure with reference to the drawings. FIG. 1 is a front view of a vehicular starting device 1. FIG. 2 is a schematic configuration diagram of the vehicle, which includes a cross-sectional view of the vehicular starting device 1. As illustrated in FIGS. 1 and 2, the vehicular starting device 1 (hereinafter, simply referred to as starting device 1) according to this embodiment performs an on/off operation of a power source such as an engine, as well as switches the running state of the vehicle among the forward movement position, the neutral position and the backward movement position. The starting device 1 is integrally controlled by a control unit 2 (see FIG. 2).

Note that the power source is coupled to the forward and backward movement switching unit via a power transmitter such as a centrifugal clutch. Namely, the power transmitter couples the power source to the forward and backward movement switching unit when the rotation speed of the power source reaches, by accelerator pedal operation, a speed equal to or more than the predetermined speed. This transmits a power from the power source to the forward and backward movement switching unit. Then, the power source, the forward and backward movement switching unit, the power transmitter, and similar units constitute a power unit 3 of this embodiment (see FIG. 2). Note that the forward and backward movement switching unit switches the running state of the vehicle (hereinafter simply referred to as range) among the forward movement position (D), the backward movement position (R), and the neutral position (N).

As illustrated in FIG. 2, the starting device 1 includes a pipe shaped cylinder body 11, a pipe shaped housing 12, and a columnar shaped rotor 13. The cylinder body 11 is, for example, internally mounted to a column cover (not illustrated), which covers a steering column. The housing 12 is disposed in the cylinder body 11. The rotor 13 is housed in the housing 12. Note that the respective central axes of the cylinder body 11, the housing 12, and the rotor 13 is positioned on a common axis (rotational axis) O. Hereinafter, a direction along the common axis O is simply referred to as axial direction. One of the sides (right side in FIG. 2) in the axial direction is referred to as a forward side, while the other side (left side in FIG. 2) is referred to as a backward side. Furthermore, a direction perpendicular to the common axis O is referred to as a radial direction, and a direction along the circumference of the common axis O is referred to as a circumferential direction.

A select switch (range switching unit) 21 is disposed at a portion of the outer peripheral surface of the cylinder body 11, the portion extending in the circumferential direction. Namely, the select switch 21 is disposed at an outside of the rotor 13 in the radial direction of the rotor 13. The select switch 21 is configured to be forwardly and backwardly movable in the radial direction through a through hole 11a disposed on the cylinder body 11 with being inwardly spring biased in the radial direction. The select switch 21 is configured to, when being pushed (pushing operation), alternately output an operation signal indicating the forward movement position (D) and an operation signal indicating the backward movement position (R) to the control unit (range switching unit) 2. For example, the control unit 2 switches the running state of the vehicle in response to the operation signal. Namely, the select switch 21 and the control unit 2 work as a range switching unit that switches the running state of the vehicle between the forward movement position that allows the vehicle to move forward and backward movement position that allows the vehicle to move backward.

A cap 23 is mounted to the front end portion of the housing 12, and covers the housing 12 and the rotor 13 from the ahead of them. The cap 23 includes a pipe portion 24 that extends coaxially with the housing 12 and an internal flange portion 25. The internal flange portion 25 inwardly projects in the radial direction from the front end edge of the pipe portion 24.

The pipe portion 24 surrounds the front end portion of the rotor 13. The rear end portion of the pipe portion 24 is mounted to the front end portion of the housing 12. As illustrated in FIG. 1, on the internal flange portion 25, signs (characters) corresponding to the operating state of an ignition switch (not illustrated) is placed in the circumferential direction with being spaced. Examples of the above-described signs on the internal flange portion 25 include “OFF,” “ACC,” “ON,” and “START.” The sign “OFF” indicates an off-position corresponding to a state in which the power source is off. The sign “ACC” indicates an accessory-position corresponding to a state in which accessory units (for example, a display unit 61) other than the power source can be supplied with electric power. The sign “ON” indicates an on-position corresponding to a state in which the power source is on. The sign “START” indicates a start position for starting the power source.

As illustrated in FIG. 2, a through hole 31, which passes through the housing 12 in a radial direction, is disposed at a portion of the housing 12 which overlaps the through hole 11a of the cylinder body 11 in the radial direction. The through hole 31 is communicatively coupled to the through hole 11a of the cylinder body 11 in the radial direction. Note that an inwardly projecting portion 32 projects at the inner end portion of the through hole 31 in the radial direction. The inwardly projecting portion 32 makes the inner diameter of the through hole 31 smaller than that of the outer end portion the through hole 31.

Then, a pushing member (acting member) 33 that can move in the radial direction is housed in the through hole 31 with being inwardly spring biased in the radial direction by the above-described select switch 21. The pushing member 33 is a member for pushing the select switch 21. The pushing member 33 includes a shaft portion 34 that extends in the radial direction, and a restricting portion 35. The restricting portion 35 is disposed at the outer end portion of the shaft portion 34 in the radial direction.

The outer end portion of the shaft portion 34 in the radial direction contacts the select switch 21 in the radial direction. The inner end portion of the shaft portion 34 in the radial direction projects into the housing 12 through the inwardly projecting portion 32 of the above-described through hole 31. Note that the inner end portion of the shaft portion 34 in the radial direction has a curved surface. The restricting portion 35 has a diameter larger than that of the shaft portion 34. The restricting portion 35 contacts the above-described inwardly projecting portion 32 from the outside in the radial direction. This restricts the pushing member 33 to move inwardly in the radial direction.

The rotor 13 is housed in the housing 12 with being forwardly spring biased by a spring biasing member (not illustrated) such that the rotor 13 can turn around the common axis O, as well as can slide in the axial direction. The front end portion of the rotor 13 forwardly projects with respect to the front end portion of the housing 12. The front surface of the rotor 13 is exposed to the outside through the internal flange portion 25 of the cap 23.

A forwardly opening key insert hole 41 extends in the rotor 13 in the axial direction. The key insert hole 41 has, for example a rectangular shape at the front view, which is being viewed from the axial direction. A key 42 is attachably/detachably inserted into the key insert hole 41 through the internal flange portion 25. Note that the key 42 has a key main body portion 43 that extends in the axial direction and, a gripping portion 44. The key main body portion 43 has a rectangular shape at cross-sectional view, which is perpendicular to the axial direction. The gripping portion 44 is consecutively coupled to the rear end portion of key main body portion 43.

A plurality of tumblers 45 extending in the radial direction is disposed in the axial direction in the rotor 13, the tumblers 45 being spaced. The tumbler 45 can move in the radial direction, as well as can engage and disengage with an engaging groove (not illustrated), which is formed between the tumbler 45 and the housing 12.

The insertion of the regular key 42 (key main body portion 43) into the key insert hole 41 (insertion state of key 42) disengages the tumbler 45 from the engaging groove. In this embodiment, the insertion of the regular key 42 (key main body portion 43) into the key insert hole 41 allows the rotor 13 to turn relative to the housing 12. Namely, the rotational movement (rotational operation) of the key 42 via the gripping portion 44 allows the rotor 13 to turn within an angle range between the sign “OFF” to the sign “START” placed on the internal flange portion 25. Then, this rotational movement switches the operating state of the ignition switch. On the other hand, the tumbler 45 is engaged with the engaging groove when the key 42 is not inserted or a key other than regular key 42 is inserted into the key insert hole 41. This causes the tumblers 45 to restrict the rotational movement of the rotor 13 relative to the housing 12.

On the outer peripheral surface of the rotor 13, a groove portion (acting member) 51, which is inwardly recessed in the radial direction, extends in the circumferential direction. Specifically, the groove portion 51 extends to a portion of the outer peripheral surface of the rotor 13 that is opposed to the pushing member 33 in the radial direction when the rotor 13 turns from the sign “OFF” to the sign “START.” The groove portion 51 houses the inner end portion of the pushing member 33 (shaft portion 34) in the radial direction. Namely, the groove portion 51 is disposed on the outer peripheral surface of the rotor 13, and houses the inner end portion of the pushing member 33 in the radial direction of the rotor 13.

In addition, the top surface of the groove portion 51 (inner end portion in the radial direction) has a flat surface 52 that is disposed in the back portion, and an inclined surface 53 that is consecutively coupled to the front end portion of the flat surface 52. The flat surface 52 positions inwardly in the radial direction with respect to the shaft portion 34 of the pushing member 33, and avoids contact between the pushing member 33 and the rotor 13. The inclined surface 53 extends such that it extends outwardly in the radial direction as extending forward. Namely, the inclined surface 53 is inclined in the slide direction of the rotor 13. The inclined surface 53 can push the pushing member 33 outwardly in the radial direction with the backward slide movement of the rotor 13. This can push (operate) the select switch 21 via the pushing member 33. Namely, the inclined surface 53 causes the pushing member 33 to move outwardly in the radial direction of the rotor 13 with the slide movement of the rotor 13 to cause the pushing member 33 to push the select switch 21. Namely, the pushing member 33 and the groove portion 51 including the inclined surface 53 work as an acting member that causes the select switch 21 and the control unit 2 to switch the running state of the vehicle with the slide movement of the rotor 13.

The above-described the control unit 2 outputs an electric signal to, for example, the power unit 3, the display unit 61, and an alarm unit 62 in response to an operation signal output from, for example, the above-described select switch 21, the ignition switch, and a brake pedal (not illustrated). In this way, the control unit 2 controls, for example, the power unit 3, the display unit 61, and the alarm unit 62.

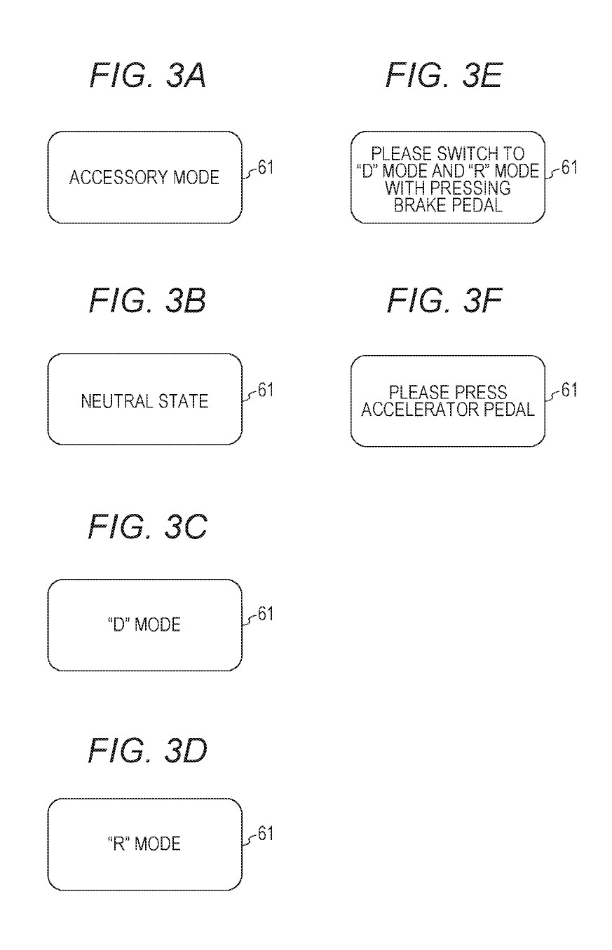

The display unit 61 is disposed, for example, on an instrument panel of the vehicle. The display unit 61 switches an image to be displayed in response to an electrical signal output from the control unit 2. The display unit 61 displays, for example, the operating state (power mode) of the ignition switch such as illustrated in FIG. 3A, the running state (range) of the vehicle such as illustrated in FIGS. 3B to 3D, and the operating method of the vehicle such as illustrated in FIGS. 3E and 3F. Note that the image displayed on the display unit 61 can be appropriately changed to another image.

The alarm unit 62 is a unit to notify the driver that the range is in the backward movement position (R) in response to an electric signal output from the control unit 2. The alarm unit 62 includes an audio output unit (for example, speaker) that outputs, for example, an alarm sound or a voice. Note that the alarm unit 62 may be a visual output unit that outputs, for example, a warning light.

The following describes the above-described starting device 1. Table I shows the power mode and the range relative to the key operation.

TABLE 1

| Key (rotor) | | | | Slide | | |
|---|---|---|---|---|---|---|
| operation | OFF | ACC | ON | movement | | START |
| Power mode | OFF | ACC | ON | Same as | Same as | START |
| | | | | on the left | on the left | |
| Range | P | P or N | N | D | R | N |

First, the range is set in the parking position (P) when the rotor 13 is in the position of “OFF” as illustrated in FIGS. 1 and 2. Then the insertion of the key main body portion 43 into the key insert hole 41 of the rotor 13 disengages the tumbler 45 is from the engaging groove. In this state, the rotation movement of the key 42 turns the rotor 13 with respect to the housing 12.

For example, when the rotor 13 is turned from “OFF” to “ACC,” the ignition switch outputs an operation signal corresponding to “ACC” to the control unit 2. Subsequently the control unit 2 outputs an electric signal corresponding to “ACC” to the power unit 3 and the display unit 61. This causes the actuator (not illustrated) to operate the forward and backward movement switching unit to switch the range from the parking position (P) to the neutral position (N). In addition, the display unit 61 displays an image indicating the power mode as illustrated in FIG. 3A. Alternatively, the display unit 61 displays an image indicating the range as illustrated in FIG. 3B. Note that, the range also may be the parking position (P) when the rotor 13 positions in “ACC.”

In addition, as illustrated in FIGS. 1 and 2, when the rotor 13 is turned from “OFF” to “START” to start the power source, and then the rotor 13 is returned to “ON,” the ignition switch outputs an operation signal corresponding to “ON” to the control unit 2. Subsequently, the control unit 2 outputs an electric signal corresponding to “ON” to the power unit 3 and the display unit 61. This causes the actuator (not illustrated) to switch the range from the parking position (P) to the neutral position (N). In addition, the display unit 61 displays an image indicating the rage as illustrated in FIG. 3B. Alternatively, the display unit 61 displays an image indicating the operating method of the starting device 1 as illustrated in FIG. 3E.

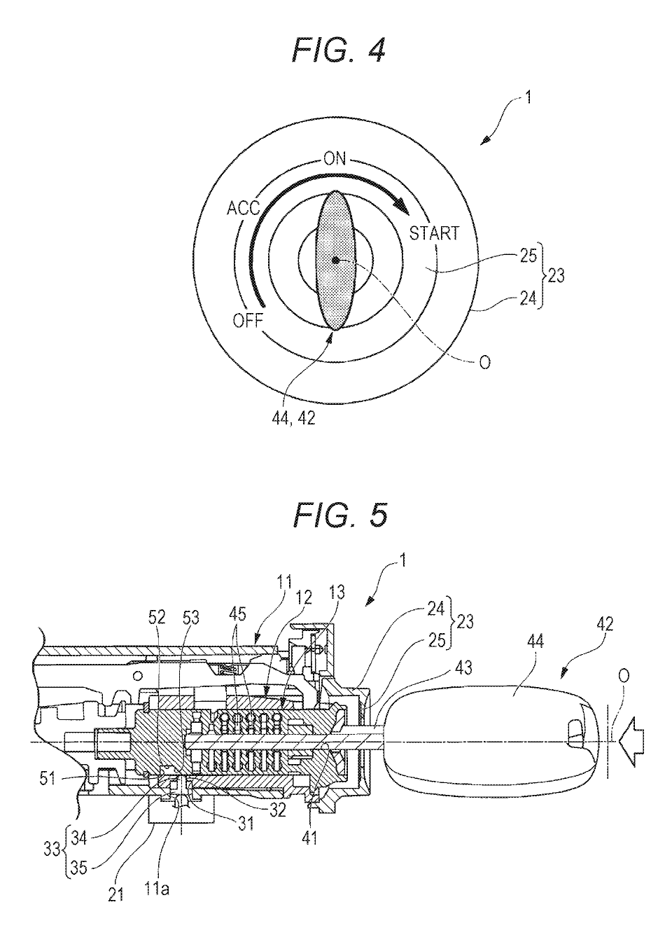

The following describes a method for switching the range to the forward movement position (D). FIGS. 4 and 5 are operation explanatory views of the starting device 1. FIG. 4 is a front view corresponding to FIG. 1, and FIG. 5 is a cross-sectional view corresponding to FIG. 2.

First, the brake pedal is pressed when the rotor 13 positions in “ON” as illustrated in FIGS. 4 and 5. This outputs an operation signal indicating that the brake pedal is in the on-state to the control unit 2. When the key 42 is backwardly pushed in this state, the rotor 13 backwardly slides with respect to the housing 12. When the rotor 13 slides, the inclined surface 53 of the groove portion 51 contacts the inner end portion of the pushing member 33 in the radial direction. Subsequently, when the rotor 13 further backwardly slides, the pushing member 33 outwardly moves in the radial direction with sliding on the inclined surface 53. This pushes the select switch 21 via the pushing member 33.

When the select switch 21 is pushed, an operation signal indicating the forward movement position (D) is output to the control unit 2. The control unit 2 outputs an electric signal corresponding to the forward movement position (D) to the power unit 3 and the display unit 61 when receiving an operation signal indicating the forward movement position (D) from the select switch 21 while the brake pedal is in the on-state. Namely, when the select switch 21 is pushed while the brake pedal is not pressed, which is in the off-state, the control unit 2 determines that the vehicle is not in the stop state, then it cancels the operation signal from the select switch 21 (cancel the switching operation of the select switch 21). Note that, at this point, the display unit 61 may an image indicating the operation method of the starting device 1 as illustrated in FIG. 3E. Namely, the control unit 2 switches the running state of the vehicle when receiving an operation signal from the select switch 21 while the brake pedal (brake) is in the on-state. On the other hand, the control unit 2 avoids switching the running state of the vehicle when receiving an operation signal from the select switch 21 while the brake pedal (brake) is in the off-state.

As illustrated in FIGS. 4 and 5, the power unit 3 causes the actuator (not illustrated) to operate the forward and backward movement switching unit to switch the range from the neutral position (N) to the forward movement position (D) when receiving an electric signal corresponding to the forward movement position (D). In addition, the display unit 61 displays an image indicating the range as illustrated in FIG. 3C. Alternatively, the display unit 61 displays an image indicating the operation method of the vehicle as illustrated in FIG. 3F.

Then, as illustrated in FIGS. 4 and 5, when the accelerator pedal is pressed while the range is in the forward movement position (D), a power from the power source is transmitted to the forward and backward movement switching unit via the power transmitter. This causes the vehicle to move forward. Note that the accelerator pedal is released when the range is in the forward movement position (D), the connection between the power source and the forward and backward movement switching unit via the power transmitter is released. Consequently, a power output from the power source is not transmitted to the forward and backward movement switching unit.

When the key 42 is released from being pushed, the rotor 13 forwardly slides with a restoring force of a spring biasing member (not illustrated). This causes the rotor 13 to return to the initial position (see FIG. 2). When the inclined surface 53 of the groove portion 51 retreats backward with respect to the pushing member 33 in the process of recovering the rotor 13, the pushing member 33 inwardly moves in the radial direction with the restoring force of the select switch 21. This causes the pushing member 33 and the select switch 21 to return to the initial position.

The following describes a method for switching the range from the forward movement position (D) to the backward movement position (R). First, the brake pedal is pressed when the rotor 13 is in the position of “ON” and the range is in the forward movement position (D). This outputs an operation signal indicating that the brake pedal is in the on-state to the control unit 2. In this state, the backward slide movement of the rotor 13 via the key 42 pushes the select switch 21 again.

When select switch 21 is pushed, an operation signal indicating the backward movement position (R) is output to the control unit 2. The control unit 2 outputs an electric signal corresponding to the backward movement position (R) to the power unit 3, the display unit 61, and the alarm unit 62 when receiving an operation signal indicating the backward movement position (R) from the select switch 21 while the brake pedal is in the on-state.

The power unit 3 causes the actuator (not illustrated) to operate the forward and backward movement switching unit to switch the range from the forward movement position (D) to the backward movement position (R) when receiving an electric signal corresponding to the backward movement position (R). In addition, the display unit 61 displays an image indicating the range as illustrated in FIG. 3D. Alternatively, the display unit 61 displays an image indicating the operation method of the vehicle as illustrated in FIG. 3F. Also, the alarm unit 62 outputs, for example, an alarm sound or a voice to the driver when receiving an electric signal corresponding to the backward movement position (R).

Then, when the accelerator pedal is pressed while the range is in the backward movement position (R), a power from the power source is transmitted to the forward and backward movement switching unit via the power transmitter. This causes the vehicle to move backward.

Note that, as described above, the select switch 21 alternately outputs an operation signal indicating the forward movement position (D) and an operation signal indicating the backward movement position (R) to the control unit 2 in response to the pushing operation. Therefore, the range is alternately switched to the forward movement position (D) and backward movement position (R) by repeated slid movement (slide operation) of the rotor 13 while the rotor 13 is in the position of “ON.”

Also, in order to stop the power source, the rotor 13 is turned to the position of “OFF.” Then, the ignition switch outputs an operation signal corresponding to “OFF” to the control unit 2. Subsequently, the control unit 2 outputs an electric signal corresponding to “OFF” to the power unit 3. This stops the power source, and switches the range to the parking position (P).

Note that the range is reset once after the power source has stopped. Namely, the range is always in the neutral position (N) when the rotor 13 positions in “ON” while next driving. Furthermore, the range is switched to the forward movement position (D) when the select switch 21 is first pushed (when the rotor 13 slides) while next driving.

Thus, in this embodiment, the slide operation of the rotor 13 along the axial direction can push the select switch 21. In this configuration, the slide operation of the rotor 13 along the axial direction can switch the range to the forward movement position or the backward movement position. This can realize a simple and small configuration of the unit compared with a conventional unit that switches the range by sliding its member in the directions perpendicular to the axial direction. Furthermore, this embodiment with employing a shift-by-wire system eliminates a need for a select lever and a connection mechanism between the select lever and a forward and backward movement switching unit, which are conventionally used. This can decrease the number of components, and also can improve space efficiency. Especially, the starting device 1 of this embodiment has a configuration in which the select switch 21 is incorporated into the rotational starting device. Accordingly, the starting device 1 of this embodiment can suppress cost increase associated with employing a shift-by-wire system.

In addition, this starting device 1 has a configuration in which the rotor 13 slides in the axial direction. This can reduce a bending stress and a shearing stress applied to the key 42. Accordingly, the key 42 can be downsized. Furthermore, the starting device 1 has a configuration in which the slide movement of the rotor in the axial direction via the key 42 can switch the range. Accordingly, this starting device 1 has higher operability. Namely, with this starting device 1, the driver can switch the range, for example, without seeing his or her hand, what is called, blind operation. Accordingly, this starting device 1 can suppress the number of times that the driver changes his or her sight while switching the range.

In addition, the starting device 1 has a configuration in which the range is switched when an operation signal is output from the select switch 21 while the brake is in an on-state. This inhibits and suppresses that the range are accidentally switched while the vehicle is travelling.

Furthermore, the display unit 61 displays the operating state of the select switch 21 and the power unit, which allows the driver to easily recognize the operating state. This can further improve operability. In addition, the alarm unit 62 can notify that the range is in backward movement position (R), which allows the driver to easily recognize that the range is in backward movement position (R). This also can further improve operability.

Above all the embodiments of this disclosure have been described in detail with reference to the drawings. The practical configurations are not limited to this embodiment, and also change, for example, their designs without departing from the technical scope of this disclosure. For example, the above-described embodiment employs the key 42 that can attachably/detachably inserted into the rotor 13 as an operator. The operator, however, is not limited to this. For example, an operating knob may be used as an operator. In this case, the operating knob is secured to the rotor 13, then the rotor 13 turns and slides via the operating knob. In addition, the above-described embodiment is described with an example in which the starting device 1 is applied to the vehicle that includes an engine as a power source. The vehicle to which the starting device 1 is applied, however, is not limited to this. Namely, the starting device 1 is also widely applicable to a vehicle including a battery as a power source such as a hybrid vehicle, an electric vehicle, and a fuel cell powered vehicle.

Also, in the above-described embodiment, the select switch 21 is disposed on the outer peripheral surface of the housing 12. Then, the select switch 21 is pushed in the radial direction. Regarding this, the design such as the disposing position of the select switch 21 can be appropriately changed as long as the select switch 21 is pushed by the slide movement of the rotor 13. For example, the select switch 21 may be disposed at a position that overlaps the rotor 13 in the axial direction.

Then, in the above-described embodiment, the select switch 21 is pushed by the pushing operation of the rotor 13. This should not be considered as a limitation. The select switch 21 may be pushed by the drawing operation of the rotor 13. Furthermore, it is acceptable that the pushing operation of the select switch 21 switches the range to one of the forward movement position (D) and the backward movement position (R), while the drawing operation of the select switch 21 may switch the range to the other one of the forward movement position (D) and the backward movement position (R).

In addition, in the above-described embodiment, the pushing operation of the select switch 21 alternately outputs an operation signal indicating the forward movement position (D) and an operation signal indicating the backward movement position (R). This should not be considered as a limitation. For example, an operation signal may be switched in response to the operation time of the select switch 21. Namely, it is acceptable that the short operation time of the select switch 21 (short push) outputs an operation signal indicating one of the forward movement position (D) and the backward movement position (R), while the long operation time of the select switch 21 (long push) outputs an operation signal indicating the other one of the forward movement position (D) and the backward movement position (R).

Also, in the above-described embodiment, the switching operation of the range is canceled when the select switch 21 is pushed while the brake pedal is in the off-state, or not pressed. This should not be considered as a limitation. For example, a restricting member, which is described below, may be disposed in the starting device 1. This restricting member engages with the rotor 13 to restrict the slide movement of the rotor 13 when the brake pedal is in the off-state. On the other hand, the restricting member disengages from the rotor 13 to allow the rotor 13 to move when the brake pedal is in the on-state.

Further, in the above-described embodiment, regarding the shape of the groove portion 51, the case in which the groove portion 51 is evenly formed along the whole circumferential direction is described. This should not be considered as a limitation. For example, it is acceptable that the inclined surface 53 or similar portion, which can push the pushing member 33, is formed only at a portion of the inner surface of the groove portion 51, which is opposed to the pushing member 33 in the axial direction when the rotor 13 is in the position of “ON.” This inhibits and suppresses that the select switch 21 is pushed when the rotor 13 is disposed in a position other than the position of “ON.” Also, a mechanism may be disposed in the starting device 1, the mechanism restricting the movement of the rotor 13 itself when the rotor 13 is disposed in a position other than the position of “ON.”

Other than that, the components of the above-described embodiment may be appropriately replaced with well-known components without departing from the scope of this disclosure.

Note that the starting device 1 may perform an on/off operation of the power source such as an engine, as well as a switching operation between the forward movement and the back movement. The pushing member 33 may be referred to as an operating member.

In addition, the vehicular starting device according to the embodiment of this disclosure may be the following first to fourth vehicular starting devices.

The first vehicular starting device includes: a rotor that can turn around a rotational axis between an on-position that causes at least a power unit of the vehicle to start and an off-position that causes the power unit to stop; an operator that operates the rotor; and a range switching mechanism that switches a running state of the vehicle to a forward movement position that allows the vehicle to move forward, or to a backward movement position that allows the vehicle to move backward. The rotor is configured to slide in a rotational axial direction, and operate the range switching mechanism with slide movement.

The second vehicular starting device according to the first vehicular starting device has a configuration in which the range switching mechanism switches a running state of the vehicle when being operated while brake is in an on-state.

The third vehicular starting device according to the first or the second vehicular starting device has a configuration in which a display unit displays operating states of the range switching mechanism and the power unit.

The fourth vehicular starting device according to the first to the third vehicular starting device has a configuration in which alarming means notifies that a running state of the vehicle is in the backward movement position.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A vehicular starting device comprising:
a rotor configured to turn around a rotational axis at least between an on-position that causes a power unit of a vehicle to start and an off-position that causes the power unit to stop, the rotor being configured to slide in a rotational axial direction,
an operator configured to operate the rotor,
a range switching unit configured to switch a running state of the vehicle between a forward movement position that allows the vehicle to move forward and a backward movement position that allows the vehicle to move backward, and
an acting member configured to cause the range switching unit to switch the running state with a slide movement of the rotor.

2. The vehicular starting device according to claim 1, wherein
the range switching unit includes:
a select switch configured to output, with being pushed, an operation signal indicating the forward movement position or an operation signal indicating the backward movement position, and
a control unit configured to switch the running state of the vehicle in response to the operation signal.

3. The vehicular starting device according to claim 2, wherein
the select switch is disposed at an outside of the rotor in a radial direction of the rotor,
the acting member includes:
a pushing member configured to push the select switch; and
a groove portion disposed on an outer peripheral surface of the rotor, the groove portion housing an inner end portion of the pushing member in a radial direction of the rotor, wherein
the groove portion includes an inclined surface that is inclined in a slide direction of the rotor, wherein
the inclined surface causes, with the slide movement of the rotor, the pushing member to move toward the outside of the rotor in the radial direction of the rotor to cause the pushing member to push the select switch.

4. The vehicular starting device according to claim 2, wherein
the control unit switches the running state of the vehicle when receiving the operation signal from the select switch while a brake of the vehicle is in an on-state.

5. The vehicular starting device according to claim 3, wherein
the control unit switches the running state of the vehicle when receiving the operation signal from the select switch while a brake of the vehicle is in an on-state.

6. The vehicular starting device according to claim 4, wherein
the control unit avoids switching the running state of the vehicle when receiving the operation signal from the select switch while a brake of the vehicle is in an off-state.

7. The vehicular starting device according to claim 5, wherein
the control unit avoids switching the running state of the vehicle when receiving the operation signal from the select switch while a brake of the vehicle is in an off-state.

8. The vehicular starting device according to claim 2, wherein
the select switch is configured to, when being pushed, alternately output the operation signal indicating the forward movement position or the operation signal indicating the backward movement position to the control unit.

9. The vehicular starting device according to claim 2 further comprising
a display unit configured to display an operating state of the select switch and the power unit.

10. The vehicular starting device according to claim 1 further comprising
an alarm unit configured to notify that the running state of the vehicle is in the backward movement position.
